(19) United States
(12) Patent Application Publication
(10) Pub. No.: US 2017/0055674 A1
(43) Pub. Date: Mar. 2, 2017

(54) Pump for Dispensing Cosmetic Product and Dispensing Device Comprising a Pump of this Type

(71) Applicant: ALBEA LACROST, Lacrost (FR)

(72) Inventor: Eric Rossignol, Chalon Sur Saone (FR)

(21) Appl. No.: 15/245,533

(22) Filed: Aug. 24, 2016

(30) Foreign Application Priority Data
Aug. 28, 2015 (FR) 1558038

(51) Int. Cl. A45D 40/00; B05B 11/00

(52) U.S. Cl. CPC A45D 40/0075; B05B 11/3028; B05B 11/3064

(57) ABSTRACT

A pump 1 for dispensing a cosmetic product, having a pump body 10 and a diaphragm 20. The pump body 10 and the diaphragm 20 are rigidly interconnected and together define an interior space 19 in the pump 1. The pump 1 is equipped with an intake valve 222, which is designed to regulate the intake of the cosmetic product into said interior space 19. The pump 115 is equipped with an outlet valve 201, which is designed to regulate the expulsion of the cosmetic product from said interior space 19. The dispensing pump 1 is designed such that the diaphragm 20 being pushed down causes the intake valve 222 to close and the outlet valve 201 to open, and such that the diaphragm 20 being released causes the outlet valve 201 to close and the intake valve 222 to open.

### CROSS-REFERENCE TO RELATED APPLICATIONS

The present application claims priority to French Patent Application No. 1558038 filed Aug. 28, 2015. The present application claims priority to and the benefit the above-identified application, which is incorporated by reference herein in its entirety.

### FIELD OF THE INVENTION

The invention relates to a pump for dispensing cosmetic product and to a dispensing device comprising a pump of this type.

### BACKGROUND

Dispensing pumps comprising a diaphragm and a pump body are known. These pumps are attached to an opening in a container containing the cosmetic product. They make it possible to dispense cosmetic product contained in the container by the diaphragm being successively pushed down and released.

However, there is a need to improve these dispensing pumps.

### SUMMARY

To do this, the invention proposes a pump for dispensing a cosmetic product, comprising a pump body and a diaphragm, said pump body and the diaphragm being rigidly interconnected and together defining an interior space in the pump, said pump being equipped with an intake valve, which is designed to regulate the intake of the cosmetic product into said interior space, and being equipped with an outlet valve, which is designed to regulate the expulsion of the cosmetic product from said interior space, the dispensing pump being designed such that the diaphragm being pushed down causes the intake valve to close and the outlet valve to open, and such that the diaphragm being released causes the outlet valve to close and the intake valve to open.

According to different aspects of the invention, which may be taken together or separately:
the pump body is designed to be connected to a container for cosmetic product,
said pump body further comprises an air intake device designed to allow air to be taken into said container,
the intake valve and/or the outlet valve are integrally formed with the diaphragm,
the diaphragm and the pump body are rigidly interconnected by welding,
the diaphragm comprises a flexible membrane,
the intake valve and/or the outlet valve are integrally formed with the flexible membrane,
the dispensing pump comprises a stiffening reinforcement to which the pliable membrane is attached,
said stiffening reinforcement is overmoulded on the flexible membrane,
the pump body and the stiffening reinforcement are made of a material of the same type,
the diaphragm and the pump body are made of different materials,
the diaphragm comprises a dome,
the outlet valve is equipped with a finger-shaped protrusion which is capable of blocking a dispensing passage formed in the pump body,
said finger is at a distance from the dome,
said finger is halfway between the dome and a peripheral portion of the diaphragm,
the dispensing passage is bent,
the dispensing passage comprises a first portion corresponding to a support seat for said protrusion,
the dispensing passage comprises a second portion corresponding to an outlet channel,
said protrusion is capable of ensuring that the dispensing passage is closed in a sealed manner when the diaphragm is in a rest position,
the intake valve comprises a flexible strip.

The invention also relates to a dispensing device comprising a container for a cosmetic product and a dispensing pump as described above, said pump being connected to the container.

### BRIEF DESCRIPTION OF THE DRAWINGS

The invention will be better understood, and its other aims, details, features and advantages will become more clearly apparent from the following detailed explanatory description of at least one embodiment of the invention, given as a purely illustrative and non-limiting example, with reference to the accompanying schematic drawings, in which:

FIGS. 1 to 4 are longitudinal sections through the dispensing pump shown in FIG. 1 in various operating configurations.

FIG. 5 is a perspective view of a longitudinal section through a dispensing pump according to a first embodiment.

FIG. 6 is an exploded perspective view of the pump shown in FIG. 1.

FIG. 7 is a perspective view of the dispensing pump shown in FIG. 1.

FIG. 8 is a perspective view of a longitudinal section through a dispensing pump according to a second embodiment.

### DETAILED DESCRIPTION OF EXEMPLARY ASPECTS

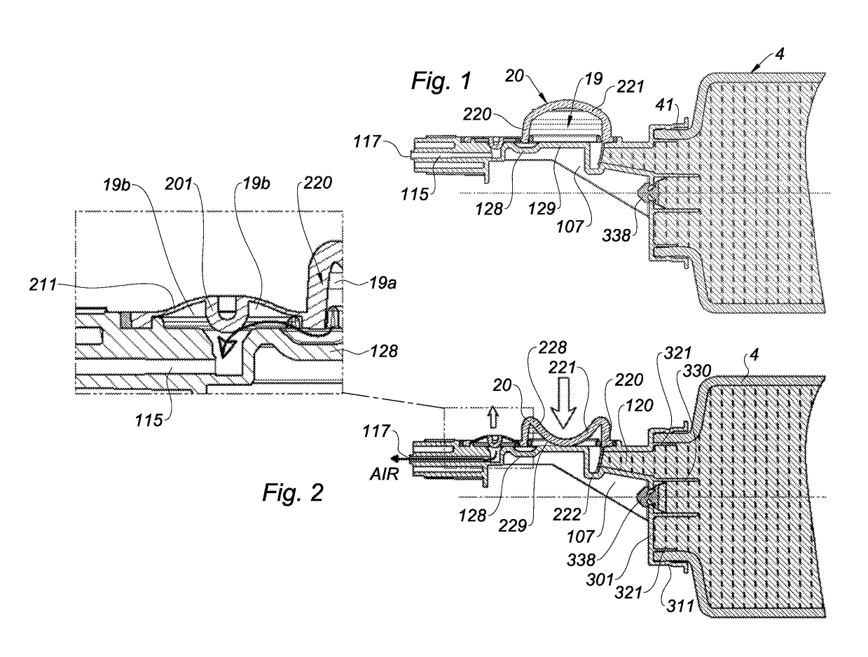

As shown in FIGS. 1 to 4, the invention relates to a pump 1 for dispensing cosmetic product. Said dispensing pump 1 in this case comprises a pump body 10 and a diaphragm 20. Said diaphragm 20 is designed to be joined to the pump body 10. It is noted that once joined to the pump body 10, the diaphragm 20 thus forms therewith a useful interior space 19 in said dispensing pump 1, which space forms a pumping chamber. Said interior space 19 in the dispensing pump 1 is designed to receive said cosmetic product.

Said dispensing pump 1 is designed to make it possible to dispense a cosmetic product, in particular from a container 4 containing said cosmetic product. In other words, the dispensing pump 1 is designed to allow the cosmetic product to be dispensed from an interior space 40 in the container 4 towards the outside, for example towards a user's hands. Said cosmetic product is for example a cream or any other product, in particular a liquid and/or viscous product.

Said container 4 is for example substantially cylindrical and has a lower end 401 and an upper end, this upper end not being visible in the drawings. The terms “lower” and “upper” are used here to distinguish between said ends without this specifying the orientation of the container 4 during use. However, a vertical orientation with the lower end positioned at the bottom is more favourable. Said container 4 extends for example longitudinally between said lower end 401 and said upper end. The container 4 is advantageously equipped with a neck 41 at one or the other of its ends, in this case at its lower end 401. An opening in the region of said neck 41 makes it possible for the cosmetic product to exit, in particular under the effect of the suction caused by the pump.

Said dispensing pump 1 is for example designed to be joined to said container 4 containing said cosmetic product. Advantageously, the dispensing pump 1 is arranged at the lower end 401 of the container 4, in the region of the neck 41 of said container 4. Alternatively, the dispensing pump 1 may be arranged at the upper end of the container 4. The dispensing pump 1 is for example designed such that it can be attached and/or rigidly connected to the neck 41 of the container 4 in a sealed manner, in particular around said neck 41, for example by screwing or by snap fitting, as is the case here. The dispensing pump 1 and said container 4 together form a dispensing device.

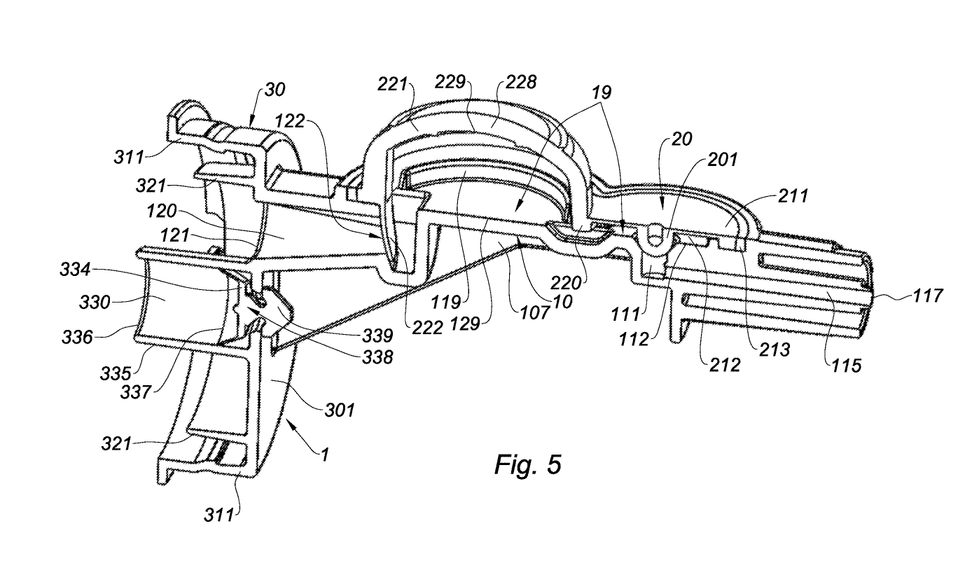

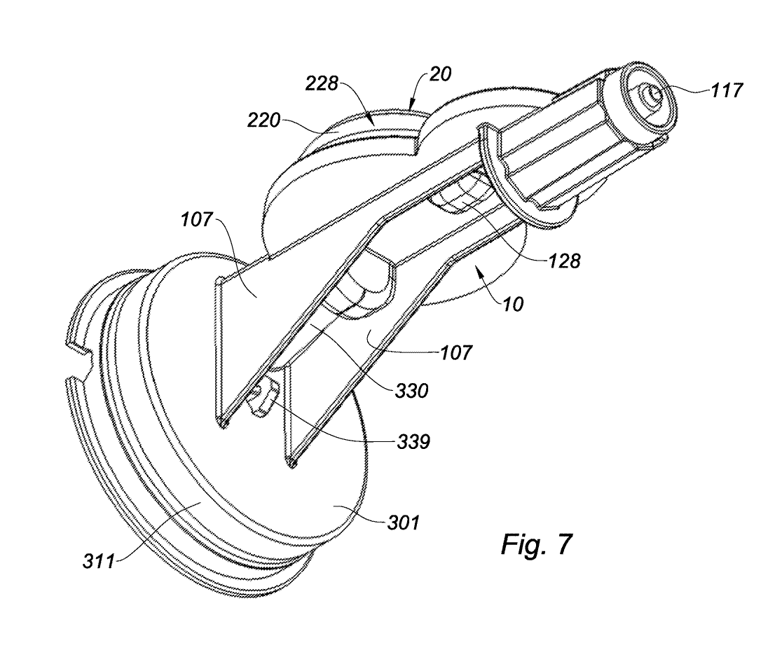

As shown in FIGS. 5 to 8, the pump body 10 comprises a base 30. Said base 30 is rigidly connected to the rest of the pump body 10. It is designed to be attached in the region of the neck 41 of the container 4, in particular by screwing or snap fitting. In other words, the base 30 makes it possible to attach, as mentioned above, the dispensing pump 1 to the container 4.

The base 30 of the pump body 10 advantageously comprises a plate 301, which is substantially circular in this case, and, in this embodiment, an air intake device.

Said base 30 is also equipped with an inner skirt 321 and an outer skirt 311. Said skirts 311 and 321 are designed to allow both sealing and attachment of the base 30 to the neck 41 of the container 4. Said skirts 311 and 321 project from the circular plate 301 of the base 30 and towards the container 4. In other words, once the base 30 and the container 4 are joined together, the inner skirt 321 and the outer skirt 311 project from the circular plate 301 in a direction extending from the lower end 401 of the container 4 towards the upper end thereof. Said skirts 311 and 321 are arranged in the region of an outer periphery of said circular plate 301 of the base 30 and extend coaxially with one another. Here, the outer skirt 311 forms a raised edge on the plate 301.

In order to allow the dispensing pump 1 to be sealed and attached and/or rigidly connected to the container 4, the inner skirt 321 and the outer skirt 311 of the base 30 are arranged and spaced apart from one another such that the neck of the container 4 can engage therebetween, in a sealed connection, in this case snap fitting, but alternatively by screwing.

In the embodiment shown, the air intake device advantageously comprises an air intake channel 330 and an air intake valve 338. The air intake device is designed to allow air to pass directly from the outside to the dispensing device, towards the interior space 40 in the container 4. Said air intake device makes it possible to equalise the pressure between these two spaces, in particular while the cosmetic product is being dispensed by means of the dispensing pump 1. In other words, said air intake device is designed to allow air to be taken in, that is to say to allow air to be introduced into the container 4 when the pressure inside said container is lower than the external pressure.

Said channel 330 is substantially cylindrical. It comprises a proximal end and a distal end 336, said proximal end being combined with the circular plate 301. Said channel 330 in this case extends perpendicularly to the circular plate 301, from said plate and towards the container 4. In other words, the channel 330 of the air intake device extends perpendicularly to the circular plate between its proximal end and its distal end 336. Said channel is positioned so as to lead into the interior of the container 4 above the neck 41.

The air intake device is equipped at its proximal end, i.e. in this case in the region of the circular plate 301, with an air intake opening. Said air intake opening is designed to be through the circular plate 301, such that it passes therethrough. Said air intake opening is for example substantially circular. In this case, said opening has a diameter that is less than a diameter of the channel 330 and is arranged substantially in the centre of the proximal end of the channel 330.

Said valve 338 is configured to prevent the cosmetic product contained in the container from exiting said container through the air intake channel 330. In the same way, said air intake valve 338 allows air to be taken in towards the interior space 40 in the container 4. Said valve 338 is arranged in the region of the circular plate 301. In particular, said valve 338 is designed to be arranged through the opening for the air intake channel 330, in the region of the proximal end thereof. It is noted that said valve 338 comprises an inner part 334 and an outer part 339, which are rigidly interconnected. Said inner part 334 is designed to be arranged in the interior space 40 in the container 4, in the air intake channel 330. Said outer part 339 is designed to project from the outside of the container 4. Each of the inner 334 and outer 339 parts of the valve 338 have dimensions, measured orthogonally to the direction of longitudinal extension of the air intake channel 330, which are greater than the diameter of the air intake opening such that the valve 338 is rigidly connected to the air intake channel 330 while leaving a free passage for the air in the region of said opening for the air intake channel.

It is noted that the outer part 339 of the valve 338 has a shape, in this case an arrow of which the tip is oriented towards the outside of the container 4, that allows said valve 338 to be snap-fitted to said air intake opening.

The inner part 334 of the valve 338 in this case comprises a skirt or a flexible extension 337. The free end of said extension 337 is designed to be in contact with an inner wall of the air intake channel 330. It is designed to prevent the cosmetic product contained in the container 4 from flowing through the air intake channel 330 and towards the outside thereof. Advantageously, the valve 338 is dimensioned such that said extension 337 exerts stress on the inner wall of the air intake channel 330, in particular given its flexibility. This stress therefore contributes to preventing the cosmetic product in the container 4 from flowing towards the outside thereof through the air intake channel 330. However, the valve 338 is designed to allow air to pass from the outside of the container 4 towards the interior space 40 therein.

When negative pressure prevails inside the container 4, said extension 337 of the valve 338 is designed to deform such that its free end is therefore at a distance from the inner wall of the air intake channel 330. The existence of a gap between the inner wall of the air intake channel 330 and the free end of the extension 337 of the valve 338 thus allows the air to flow from the outside of the container 4 towards the interior space 40 therein. In other words, the valve 338 is designed to deform under the effect of said negative pressure in order to allow air to flow towards the inside of the container 4.

Furthermore, it should be noted that said inner 334 and outer 339 parts of the valve 338 are in this case spaced apart from one another by a distance that is greater than a thickness of the plate 301 such that that valve 338 has functional play relative to said plate 301. Said functional play makes it possible to move the valve 338 through said air intake opening and in a direction perpendicular to the plate 301. In this way, the inner part 334 of the valve 338 is capable of blocking or unblocking said air intake opening depending on a pressure difference between the outside and the interior space 40 in the container 4.

In a variant which is not shown, there is no device for taking in air towards the inside of the container 4.

The pump body 10 comprises an inlet passage 120, a dispensing passage 115 and a planar part 129. Said planar part 129 of the pump body 10 is designed to be opposite at least part of the diaphragm 20. More specifically, an inner surface of the planar part 129 is designed to be arranged opposite an inner surface 229 of the diaphragm 20, the two inner surfaces being separated from one another by the interior space 19 in the dispensing pump 1, or being in contact at points. It is also noted that the planar part 129 of the pump body 10 is in this case designed such that it extends substantially orthogonally to the circular plate 301 of the base 30 of the dispensing pump 1.

The inlet passage 120 is designed to be directly connected to the interior space 40 in the container 4. In particular, the inlet passage 120 is designed to interconnect the interior space 40 in the container 4 and the interior space 19 in the dispensing pump 1.

Said inlet passage 120 comprises a substantially frustoconical channel which extends from the plate 301 of the base 30 in an opposite direction to the interior space 40 in the container 4. In other words, the channel of the inlet passage 120 advantageously projects from the circular plate 301 of the base 30 and substantially orthogonally thereto. Said channel comprises an intake opening 121 and an outlet opening 122, and extends between these two openings 121 and 122. The inlet opening 121 is designed to pass through the plate 301 of the base 30. It is positioned in the region of the lower end 401 of the container 4. The outlet opening 122 is positioned close to the interior space 19 in the dispensing pump 1.

The dispensing passage 115 connects the interior space 19 in the dispensing pump 1 to the outside. Said dispensing passage 115 advantageously comprises a channel which is substantially cylindrical. Said channel comprises an intake opening and an outlet opening 117, and extends between these two openings. Said outlet opening 117 leads to the outside. Said intake opening is arranged in the region of a well 111 of said dispensing passage 115. Said well is in communication with the interior space 19 in the dispensing pump 1. It is orthogonal to said channel equipped with the outlet opening 117.

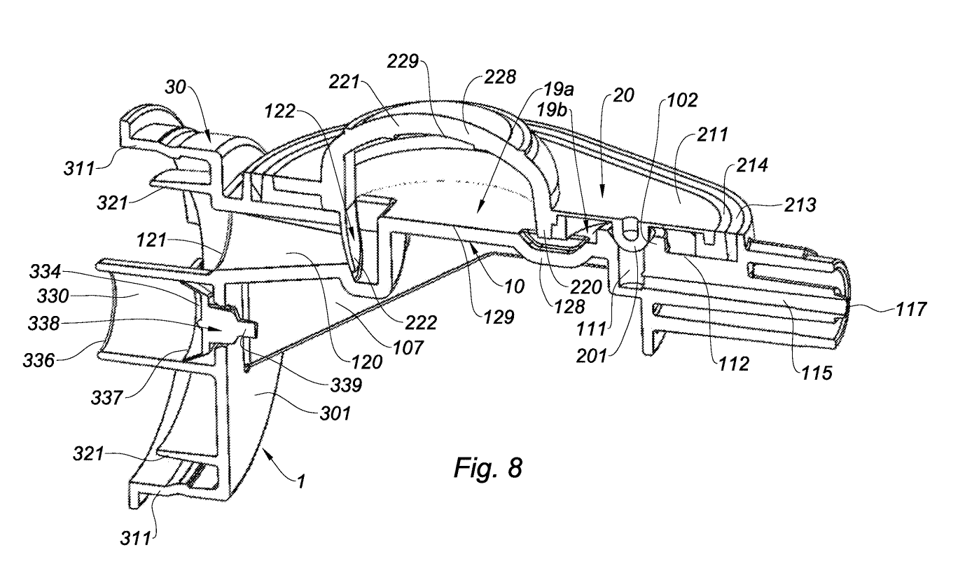

As shown in FIG. 8, the channel of the dispensing passage 115 is surrounded by a protective skirt. Said protective skirt and said channel are coaxial.

Advantageously, each of the dispensing 115 and inlet 120 passages is equipped with a valve. Therefore, the inlet passage 120 is equipped with an inlet valve 222 in the region of its end 122. The dispensing passage 115 is equipped with a dispensing valve 201 in the region of said well 111.

In this case, the diaphragm 20 comprises a pliable and/or flexible membrane. It is elastically deformable such that it can return to its original shape itself after deformation. Said pliable membrane advantageously comprises a first part 228 and a second part 211. Said two parts 228 and 211 are advantageously rigidly connected and are integrally formed with one another.

The first part 228 of the diaphragm 20 in this case comprises a circular base 220 and a dome 221 projecting from said circular base 220 and in the opposite direction to the pump body 10. In other words, said dome 221 is convex towards the outside. In other words again, the dome 221 has a substantially semi-spherical shape, the convex surface of the half-sphere being oriented towards the outside.

The dome 221 of the diaphragm 20 is designed to be able to be pushed down by a user towards the planar part 129 of the pump body 10, in particular by pressure exerted for example by one of their fingers, or by a mechanical device such as a lever. In other words, the diaphragm 20 is designed to be able to be pressed towards the planar part 129 of the pump body 10.

The second part 211 of the diaphragm 20 is advantageously planar. Said second part 211 of the diaphragm 20 and the planar part 129 of the pump body 10 are advantageously parallel to the same plane.

Said inlet valve 222 comprises a strip, for example. In this case, said strip projects from the circular base 220 of the diaphragm 20, towards the pump body 10. Said strip advantageously has a thickness that is less than that of the dome 221. This low thickness provides greater flexibility of the strip. Said strip is arranged in the region of the inlet passage 120 of the pump body 10. More specifically, it is designed to block the outlet opening 122 of the inlet passage 120 in a sealed manner.

Said inlet valve 222 is advantageously integrally formed with the first part 228 of the diaphragm 20.

In this case, the second part 211 of the diaphragm is thinner than the dome 221 of the diaphragm 20. In other words, the second part 211 advantageously has a lower thickness than that of the dome 221. This thinning makes it possible to increase the flexibility of said second part 211 of the diaphragm 20. Said second part 211 is circular in this case and is connected to the dome over a shared angular sector, for example approximately 90 degrees. It is equipped in the centre with said outlet valve 201. Said outlet valve 201 comprises a protrusion projecting from said centre of the second part of the diaphragm 20. Said protrusion is advantageously finger-shaped and is dimensioned such that it can be inserted at least in part into the dispensing passage 115, in the region of its well 111, and can block said passage. In other words, said protrusion of the outlet valve 201 is designed to be inserted into the dispensing passage 115 through the well 111 thereof. The outlet valve 201 is designed to prevent the cosmetic product, or air when the dispensing device is initiated, from flowing between the interior space 19 in the dispensing pump 1 and the outside. Said outlet valve 201 is advantageously integrally formed with the second part 211 of the diaphragm 20.

The second part 211 of the diaphragm 20 is designed to be able to raise up under the effect of a pressure increase in the pumping chamber 19. In particular, under the effect of the pressure of the product to be dispensed. the second part 211 of the diaphragm is designed to deform by bending towards the outside, that is to say in the opposite direction to the pump body. Said second part 211 of the diaphragm is designed such that when it raises up, it brings with it the valve 201, which has the effect of opening the well 111 of the dispensing passage 115. In other words, when the second part 211 of the diaphragm 20 raises up under the effect of the pressure of the cosmetic product or another fluid such as air, bringing with it the finger-shaped protrusion of the dispensing valve 201, said protrusion is at a distance from an intake opening for the dispensing passage 115.

As mentioned above, said inner surfaces 229 and 129 of the diaphragm 20 and the pump body 10, respectively, are designed to be arranged opposite one another. The inner surface 129 of the pump body, like the inner surface 229 of the diaphragm, are designed to be in contact with the cosmetic product, in particular when the cosmetic product fills the interior space 19 in the dispensing pump 1.

It is noted that the interior space 19 in the pump 1 comprises two parts. A first part 19a corresponds to the space located below the dome, while a second part 19b corresponds to the space located below the second part 211 of the diaphragm.

In the region of a join between the first part and the second part of the diaphragm 20, the pump body 10 further comprises a cavity or deformation 128. In this case, said cavity 128 forms a passage or channel between the first part 19a of the interior space in the pump 1 and the second part 19b thereof. In other words, said cavity 128 is in particular designed to allow the cosmetic product or air to pass between the first 19a and second 19b parts of said interior space 19.

In this case, it is noted that the inlet passage 120 and the dispensing passage 115 are bent, substantially at right angles. Therefore, both said inlet passage 120 and dispensing passage 115 comprise a first portion and a second portion. The first portions extend longitudinally in a direction that is substantially perpendicular to the circular plate 301 of the base 30 of the pump body 10. The second portions, such as the well 111, extend in a direction that is substantially in parallel with the direction in which the diaphragm 20 is pushed down.

In the following, the operation of the dispensing device 1 is described with reference again to FIGS. 1 to 4.

As shown in FIG. 1, when the dispensing pump 1 is joined and rigidly connected to the container 4 for the first time, said pump 1 advantageously does not contain any cosmetic product. In other words, the interior space 19 in the pump 1 is without cosmetic product and is filled with air. The diaphragm 20 is therefore in a rest position. This means that no pressure is being exerted on the diaphragm 20, which therefore maintains its convex shape as described above. In other words, the convex face of the dome 221 is oriented towards the outside. In this configuration, the inlet valve 222 and dispensing valve 201 are each in a rest position. In other words, the inlet valve 222 hermetically blocks the inlet passage 120 and the dispensing valve 201 hermetically blocks the dispensing passage 115. In other words again, the strip of the inlet valve 222 entirely covers the outlet opening 122 of the inlet passage 120 and the protrusion of the second part 211 of the diaphragm 20 entirely blocks the intake opening of the dispensing passage 115. Moreover, it is noted that, in this configuration, the air intake channel 330 is blocked by the air intake valve 338.

During the first use, as shown in FIG. 2, and in order to cause the cosmetic product to be dispensed from the inside of the container 4, the user exerts pressure on the dome 221 of the diaphragm 20, for example using one of their fingers. The pressure exerted causes the diaphragm 20 to be pushed down. In this case, said pressure is understood to be a force that is advantageously exerted in parallel with the direction in which the diaphragm 20 is pushed down, that is to say orthogonally to the planar part 129 of the pump body 10, and towards said planar part. In other words, the diaphragm 20 is designed to be pushed down under the effect of said pressure exerted by the user. In other words, pushing down the diaphragm 20 is intended to mean deformation of the diaphragm 20, the top of which thus comes closer to the pump body 1, in particular to the planar part 129 of the pump body 10. The diaphragm being pushed down corresponds to a reduction in the volume of the interior space 19 in the dispensing pump 1.

One result of this reduction is that the pressure in the interior space 19 is increased.

The strip of the inlet valve 222 is designed and arranged such that the pressure exerted by the air contained in the first part 19a of the diaphragm 20 presses said strip of the inlet valve 222 against the outlet opening 122 of the inlet passage 120. The inlet valve 222 thus continues to obstruct the inlet passage 120. The air compressed inside the first part 19a thus flows through the cavity 128 in the pump body 10 and passes from the first part 19a to the second part 19b of the interior space. The pressure exerted on the second part 211 of the diaphragm causes said diaphragm to raise up by means of elastic deformation. When raising up, said second part 211 brings with it the finger-shaped protrusion of the dispensing valve 201, thus unblocking the intake opening 111 of the dispensing passage 115. The air thus rushes into the inside of said dispensing passage 115 and is expelled towards the outside of the pump 1 through the outlet opening 117 of said dispensing passage 115. This air flow towards the outside continues until the pressure equalises between the interior space 19 in the diaphragm and the outside. The second part 211 of the diaphragm 20 therefore assumes its rest position again, in which the dispensing valve blocks the intake opening 111 of the dispensing passage 115.

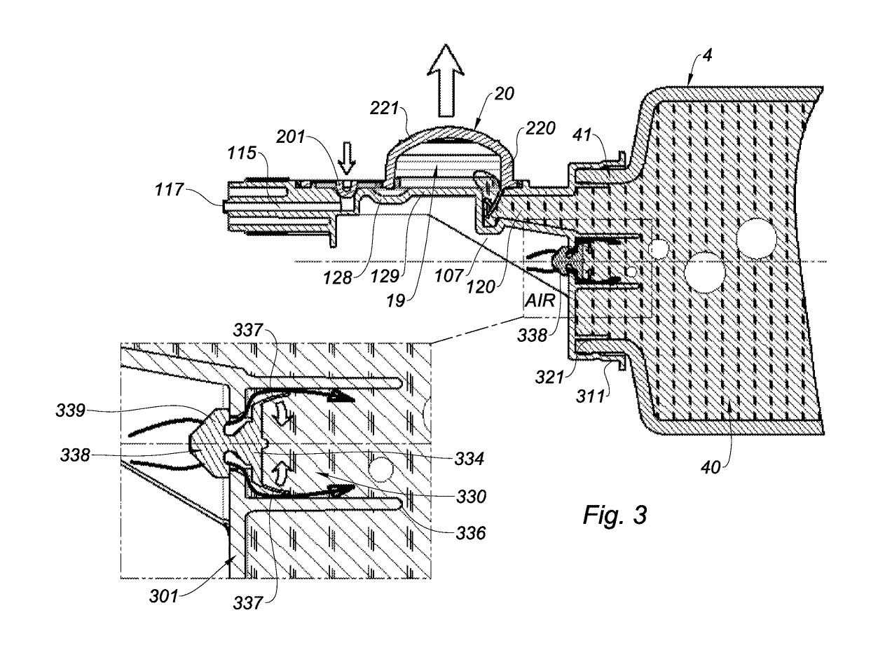

As shown in FIG. 3, when the user stops pressing on the diaphragm and/or removes their finger therefrom, the dome 221 of the diaphragm 20 returns to its rest position. During the phase in which the diaphragm 20 returns to its rest position, the volume of the interior space 19 in the pump body 1 increases. This increase in volume leads to a reduction in the pressure in the interior space 19. Under the effect of this pressure reduction, the protrusion of the dispensing valve 201 remains pressed against the intake opening of the dispensing passage 115. Simultaneously, the pressure inside the container 4 becomes higher than the pressure in the interior space 19 in the pump 1. Therefore, the strip of the inlet valve 222 deforms and part of said strip, including its free end, moves towards the interior space 19 in the pump 1. In other words, at least part of the strip of the inlet valve 222 moves away from the outlet opening 222 such that it opens said opening at least in part. The cosmetic product contained in the container 4 thus moves through the inlet passage 222 and then fills the interior space 19 in the pump 1 at least in part. This filling continues until the pressures equalise between the inlet passage 120 and the interior space 19 in the pump 1. When the pressure has equalised and the dome 221 is in its rest position again, the strip which elastically deformed returns to its original position so that it blocks the outlet opening 122 of the inlet passage 120 again.

When the cosmetic product moves from the container 4 towards the inlet passage 120, and then from the inlet passage 120 towards the interior space 19 in the pump 1, this movement of the cosmetic product produces a negative pressure inside the container 4. One of the consequences of this negative pressure inside the container 4 is that the atmospheric pressure, that is to say the pressure outside the dispensing device, becomes higher than the pressure inside the container 4. In particular, the pressure inside the air intake channel 330, in the part thereof between the distal end 336 of air channel 330 and the inner part 334 of the air intake valve 338, becomes lower than the pressure between said inner part 334 of the air intake valve 338 and the outlet opening of the air intake channel 330. This pressure differential on either side of the inner part 334 of the air intake valve 338 causes the extension of the inner part 334 of the air intake valve 338 to deform. In particular, said extension deforms such that the inner part 334 no longer obstructs the air intake channel 330 and thus allows air to be taken into the container. Pressing on the diaphragm 20 one or more times thus makes it possible to initiate the pump 1.

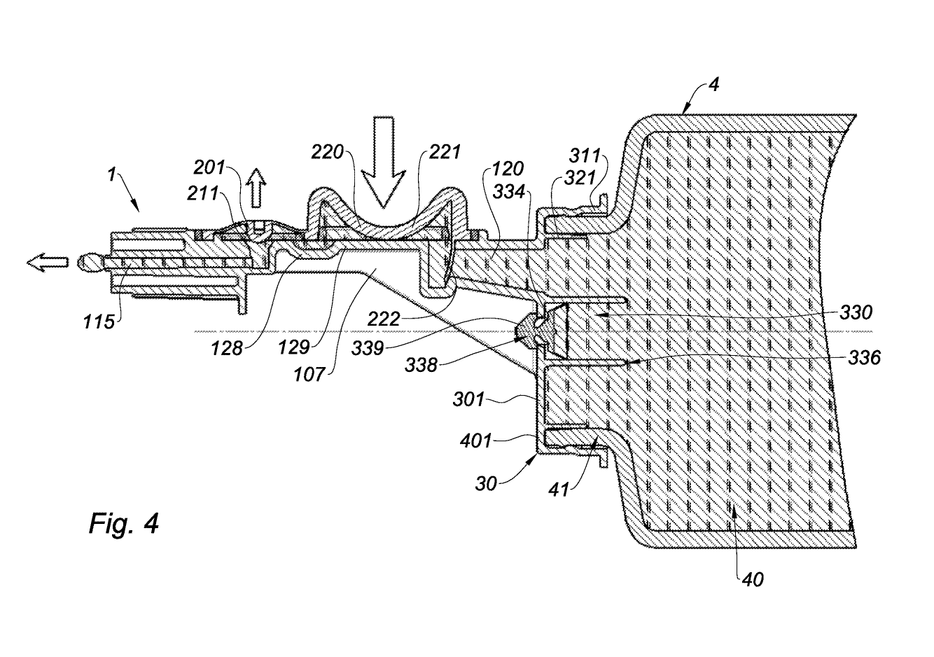

As shown in FIG. 4, after initiation, the user pressing on the diaphragm 20 once again makes it possible to dispense the cosmetic product using an identical mechanism to that described above, allowing air to be expelled from said interior space 19 in the pump towards the outside. The difference is that, this time, it is the cosmetic product initially contained in the container 4, and not air, that is expelled through the passage. The diaphragm being pushed down also allows the interior space 19 to be filled with a new dose of cosmetic product at the point when the diaphragm 20 returns to its rest position.

Advantageously, the pump body 10 and the diaphragm 20 are made of different materials. In particular, the pliable membrane of the diaphragm 20 is made of plastics elastomer. The pump body 10 is made of polypropylene in this case.

The diaphragm 20 is advantageously rigidly connected to the pump body 10 by welding. In particular, the dispensing pump 1 comprises a weld seam 213, for example made of polypropylene. In other words, the weld seam 213 is made of an identical material to that in which the pump body 10 is designed. Said weld seam 213 is designed to be arranged at the periphery of the diaphragm between the pump body 10 and said periphery of the diaphragm 20.

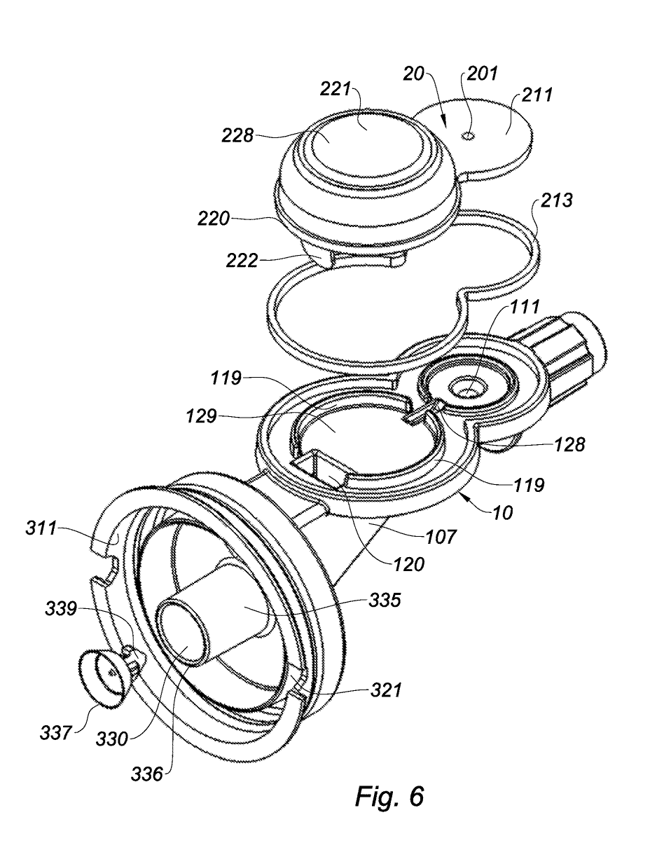

It is noted that, as can be seen in particular in FIGS. 5 and 6, the planar part 129 is equipped on its inner surface with two semi-circular positioning ribs 119. These ribs 119 are designed to allow the diaphragm 20 to be positioned relative to the pump body 10.

In a particular embodiment, shown in FIG. 8, the dispensing pump further comprises a stiffening reinforcement 214. Said stiffening reinforcement 214 is thus arranged between the diaphragm 20 and the weld seam 213. The pliable membrane of the diaphragm is therefore attached to the stiffening reinforcement 214, which is located at its periphery. In particular, said stiffening reinforcement 214 is overmoulded on the pliable membrane. Said stiffening reinforcement 214 is for example made of the same material as that which forms the pump body 10. In other words, the stiffening reinforcement 214 is in this case made of polypropylene. It is noted that in this particular embodiment, the well 111 is equipped with a ring 102 projecting from the planar part 129. Differing from the first embodiment, it is said ring 102 that acts as a seat for the protrusion of the outlet valve 201.

It is advantageously noted that the air intake valve 338 is made of polyethylene.

Advantageously, the pump 1 is equipped with a device for assisting an assembly operator and/or a user when mounting the dispensing pump 1 on the container 4. In particular, the outer skirt 311 of the base 30 of the pump body 10 is equipped with notches 312 at its free end. Said notches 312 are designed to allow the pump 1 to be appropriately positioned, in particular angularly and/or in terms of depth, relative to the container 4. There are, for example, two of said notches 312, and they are diametrically opposite one another. Said notches 312 are substantially rectangular in this case. Said notches 312 are for example designed to cooperate mechanically with pins arranged in the region of the neck of the container 4 and/or on said neck.

It is noted that the pump body 10 is advantageously equipped with two reinforcing ribs 107 which extend perpendicularly both to the planar part 129 and to the circular plate 301. Said ribs 107 extend in parallel with one another and on either side of the depression 128 and the inlet passage 120.

1. Pump for dispensing a cosmetic product, comprising a pump body and a diaphragm, said pump body and the diaphragm being rigidly interconnected and together defining an interior space in the pump, said pump being equipped with an intake valve, which is designed to regulate the intake of the cosmetic product into said interior space, and being equipped with an outlet valve, which is designed to regulate the expulsion of the cosmetic product from said interior space, the dispensing pump being designed such that the diaphragm being pushed down causes the intake valve to close and the outlet valve to open, and such that the diaphragm being released causes the outlet valve to close and the intake valve to open.

2. Dispensing pump according to claim 1, wherein said pump body is designed to be connected to a container for cosmetic product, said pump body further comprising an air intake device designed to allow air to be taken into said container.

3. Dispensing pump according to claim 1, wherein the intake valve and/or the outlet valve are integrally formed with the diaphragm.

4. Dispensing pump according to claim 1, wherein the diaphragm and the pump body are rigidly interconnected by welding.

5. Dispensing pump according to claim 4, wherein the diaphragm and the pump body are made of different materials.

6. Dispensing pump according to claim 1, wherein the diaphragm comprises a pliable membrane.

7. Dispensing pump according to claim 6, further comprising a weld seam that is designed to make it easier to weld the pliable membrane to the pump body.

8. Dispensing pump according to claim 7, wherein the dispensing pump comprises a stiffening reinforcement to which the pliable membrane is attached.

9. Dispensing pump according to claim 8, wherein said stiffening reinforcement is overmoulded on the pliable membrane.

10. Dispensing pump according to claim 8, wherein the pump body and the stiffening reinforcement are made of a material of the same type.

11. Dispensing pump according to claim 1, wherein the diaphragm comprises a dome.

12. Dispensing pump according to claim 1, wherein the outlet valve is equipped with a finger-shaped protrusion which is capable of blocking a dispensing passage formed in said pump body.

13. Dispensing pump according to claim 12, wherein the dispensing passage is bent.

14. Dispensing pump according to claim 12, wherein said protrusion is capable of ensuring that the dispensing passage is closed in a sealed manner when the diaphragm is in a rest position.

15. Dispensing device comprising a container for a cosmetic product and a dispensing pump according to claim 1, said dispensing pump being connected to said container.
